(19) United States
(12) Patent Application Publication
(10) Pub. No.: US 2007/0186377 A1
(43) Pub. Date: Aug. 16, 2007

(54) Fixing device for a slide or guide rail

(75) Inventor: Thomas Pabst, Schwelm (DE)

Correspondence Address: COHEN, PONTANI, LIEBERMAN & PAVANE, 551 FIFTH AVENUE, SUITE 1210, NEW YORK, NY, 10176, US

(73) Assignee: Dorma GmbH + Co. KG, Ennepetal (DE)

(21) Appl. No.: 10/589,941

(22) PCT Filed: Feb. 15, 2005
(86) PCT No.: PCT/EP05/01509

§ 371 Date: Aug. 18, 2006

(30) Foreign Application Priority Data
Feb. 18, 2004 (DE) 10 2004 008 117.4

(51) Int. Cl. E05D 15/00

(52) U.S. Cl. 16/94 R

(57) ABSTRACT

An attachment device for a slide channel for a door closer, including a clamping piece insertable into an end of the slide channel, the clamping piece having a first outside surface and a first toothing on the first outside surface; and a connecting plate integrally formed with the clamping piece and having a bore by which the connecting plate can be connected to a sub-construction. When the clamping piece is inserted into the end of the slide channel, the connecting plate is disposed outside of the slide channel, and the first toothing abuts against a first inside surface of the end of the slide channel by press fit so that the clamping piece is detachably interlocked with the slide channel.

The invention relates to an attachment device for a slide channel or guide rail, which are used in particular for door closers. The sliding block of a door closer is guided for example in a slide channel of this species. As the sliding block is connected to the arm of the door closer, the slide channel is substantially C-shaped, i.e. it has a lateral opening in which the arm of the door closer engages with the associated sliding block. The slide channel itself is attached to a door or to a frame. An attachment device disposed on the face side of the slide channel serves for this purpose in a known manner, which device has a clamping piece engaging into the slide channel and, outside the profile of the slide channel, a connecting plate integrally connected to the clamping piece. The connecting plate has a bore by means of which the connecting plate and thus the slide channel can be connected to the door or to the frame. In prior art devices, the blocking between the clamping piece, which engages on the face side in the slide channel, and the slide channel is realized by a clamping screw penetrating the clamping piece, which screw allows to achieve interlocking between the clamping piece and the slide channel. On the one hand, this requires a threaded bore in the clamping piece, which for visual reasons needs in addition to be countersunk; on the other hand, there is the risk that the attachment bolt, which is detectable from the outside, may unintentionally self-disengage.

It is an object of the invention to improve an attachment device of the species mentioned above in that an expensive and visually unattractive screw connection between the clamping piece and the slide channel or guide rail can be eliminated. In an advantageous further development of the invention, the attachment device is to be formed in that a technically simple and visually appealing cover for the attachment device and thus for the termination on the face side of the profile of the slide channel or guide rail is achieved.

The invention solves of the given problem with the teaching according to claim 1.

Therefore, on at least one outside wall, the clamping piece has a toothing, which abuts against an inside wall of the profile of the slide channel or guide rail by means of a press fit, and which, in an advantageous embodiment of the invention, at two diametrally opposite outside walls abuts against two opposite inside walls of the profile.

According to the above technical teaching, the clamping piece, which is integrally formed with the connecting plate, can be non-positively pressed into the slide channel or guide rail on the face side without requiring a screw connection between the clamping piece and the guide rail.

Further advantageous embodiments of the invention are the subject matter of the dependent claims.

The clamping piece's toothing is preferably formed as an inclined toothing, the inclination of the teeth being such that pressing the clamping piece into the profile requires less expenditure of energy than the principally possible release of the clamping piece from the profile, which accordingly requires a higher expenditure of energy. Thus, a reliable blocking of the clamping piece in the profile is guaranteed.

The connecting plate, which is integrally formed with the clamping piece, has a stop face, which, with the clamping piece being completely inserted into the profile, abuts against an end surface of the profile and thus blocks the position of the clamping piece in the profile.

Moreover, the connecting plate is formed such that a surface of the connecting plate abutting against the sub-construction extends flush with an outside wall of the profile oriented towards the sub-construction.

In a particularly advantageous embodiment of the invention, the connecting plate has locking components for clampingly connecting a cover cap, which overlaps the connecting plate and covers the profile on the face side, the connecting plate having projections and/or recesses at the opposite lateral surface thereof extending orthogonally in relation to the surfaces adjoining the sub-construction, whereby, projections, which are disposed in advantageous manner on the opposite lateral surfaces of the connecting plate, form the complementary locking components for the recesses disposed at the cover cap. Thus, the connecting plate does not only serve as an attachment for the slide channel or guide rail at a sub-construction, but furthermore it has the complementary locking components for a cover cap, which forms a covering for both the connecting plate and for the entire covering on the face side of the profile of the slide channel or guide rail.

The bore, in a way which is known per se, is formed as an oblong hole in the connecting plate, in order to be able to compensate for important tolerances when connecting the slide channel or guide rail to a sub-construction.

Generally the slide channels or guide rails consist of an aluminium alloy, however, principally they may be produced from any optional material. As a sufficient frictional connection is required between the toothing of the clamping piece and the profile of the slide channel or guide rail, the choice of material of the attachment device, i.e. particularly of the clamping piece, needs to match the material of the slide channel or guide rail. As a result, the embodiment of the invention may require the use of appropriate plastic material, aluminium material or zinc-die cast for the attachment device.

In the following, the invention will be described in more detail, reference being made to one possible exemplary embodiment, in which

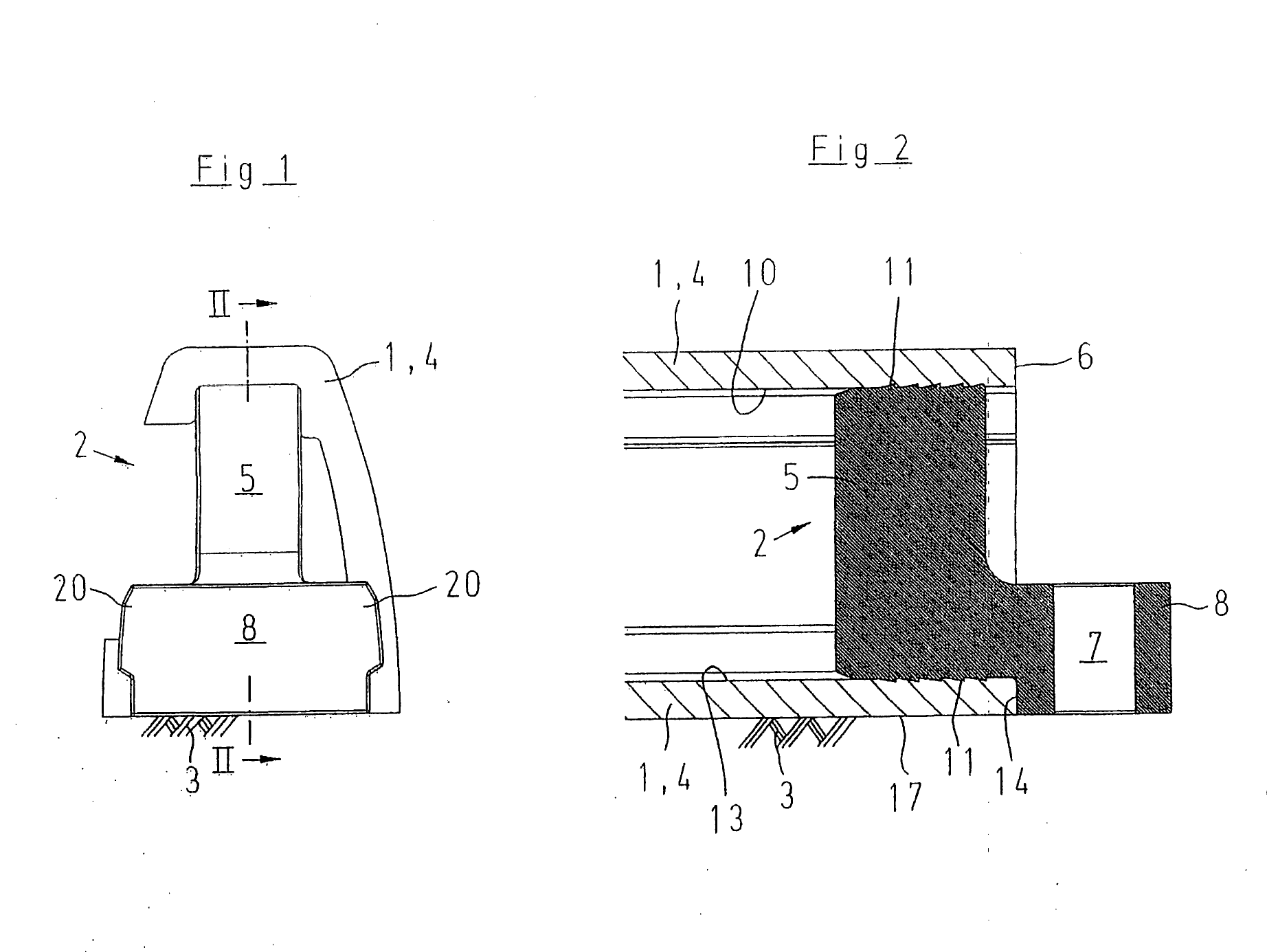

FIG. 1: shows a view on the end surface of the attachment device in a slide channel.

FIG. 2: shows the section according to line II-II in FIG. 1.

FIG. 3: shows a lateral view of the attachment device according to FIG. 1.

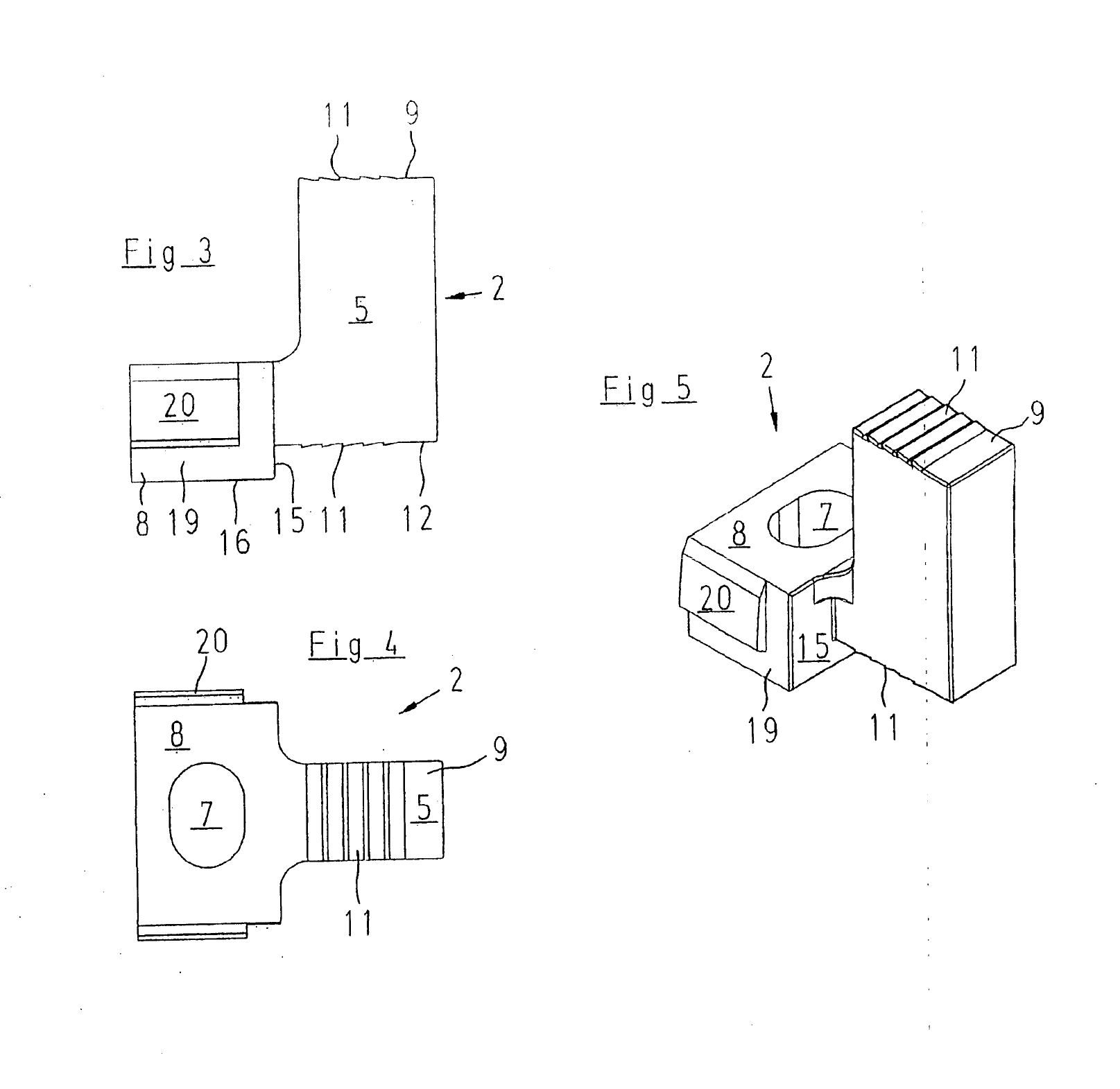

FIG. 4: shows a plane view according to FIG. 3.

FIG. 5: shows a perspective illustration of the attachment device.

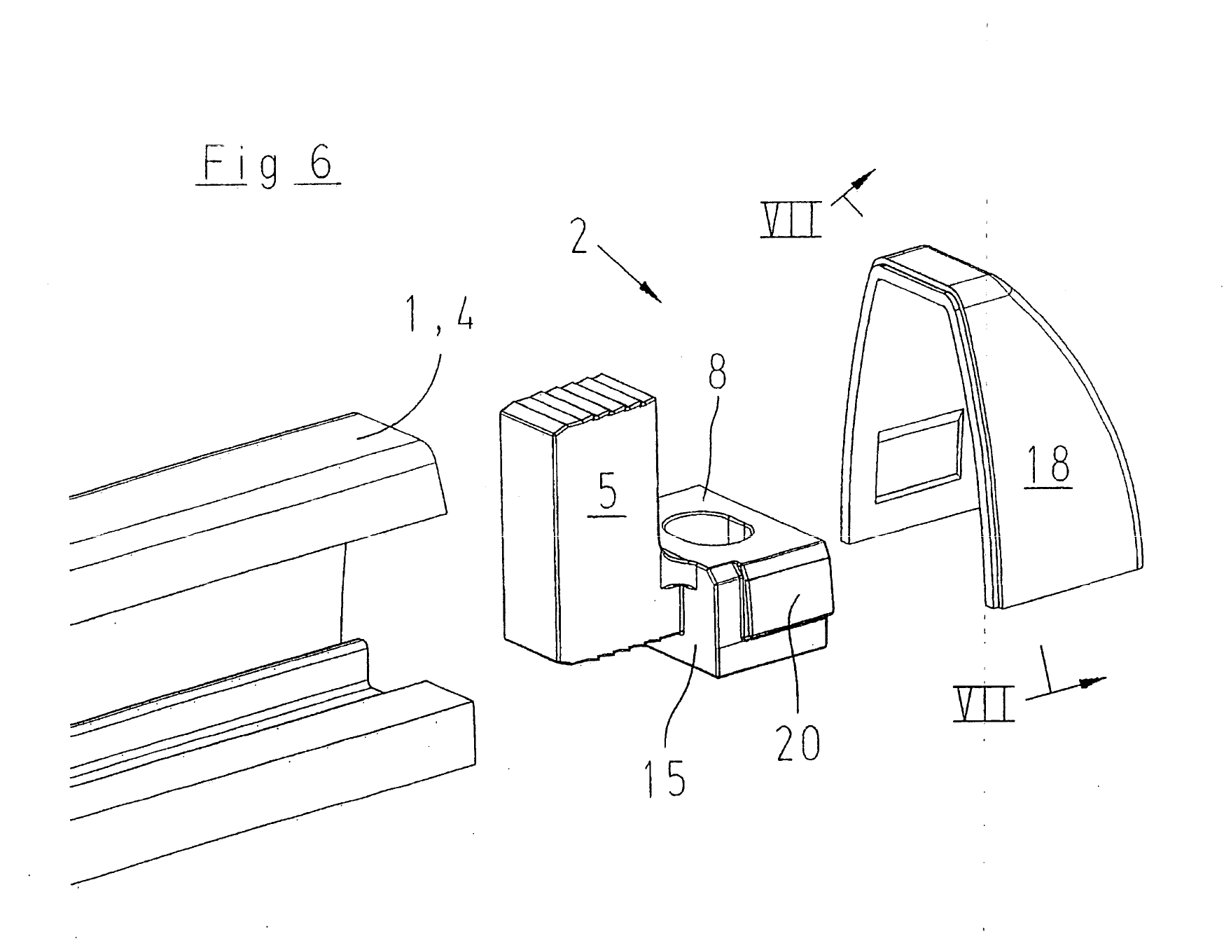

FIG. 6: shows the slide channel including the attachment device and the cover cap in a perspective exploded view.

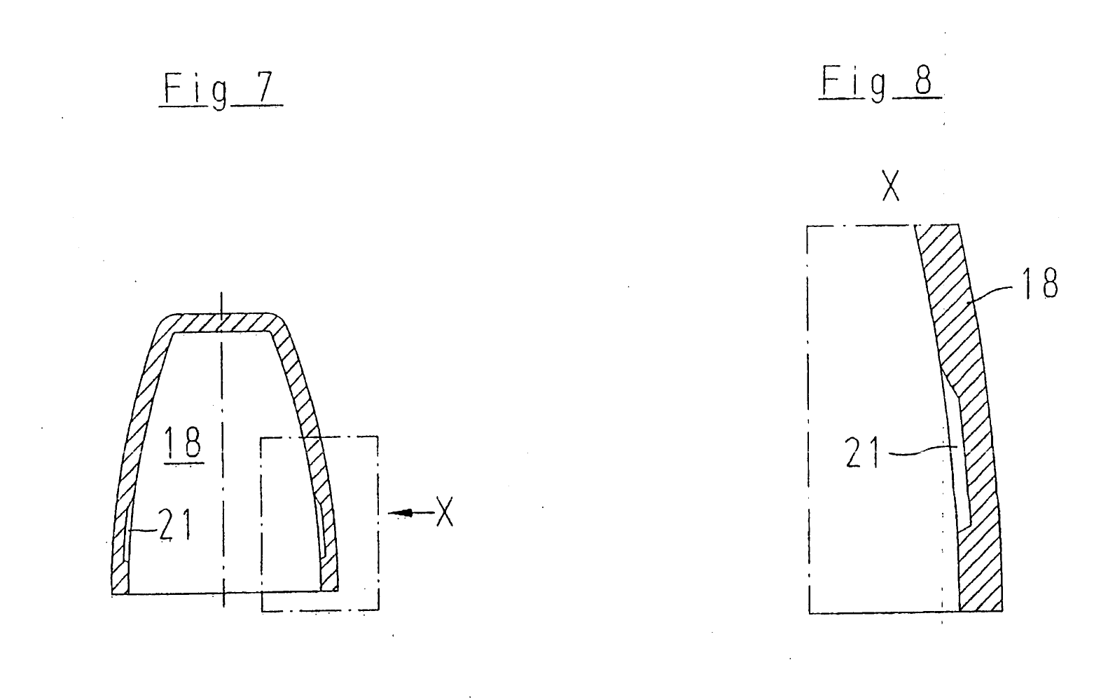

FIG. 7: shows the section VII-VII through the cover cap according to FIG. 6.

FIG. 8: shows the detail X in an illustration, which is enlarged in relation to FIG. 7.

According to the illustrated drawings, an attachment device 2 is disposed in the area of a termination 6 on the face side of a profile 4 of a slide channel 1. The attachment device 2 substantially consists of a clamping piece 5 and of a connecting plate 8, which is provided with a bore 7. As particularly illustrated in FIG. 2, the clamping piece 5, on two diametrally opposite sides, has a toothing 11, which is formed as an inclined toothing and, in the exemplary embodiment according to FIG. 2 in the plane of the illustration, abuts against an upper inside wall 10 and against a lower inside wall 13 of the profile 4. The toothing 11 is formed respectively on diametrally opposite outside walls 12 of the clamping piece 5. If the clamping piece 5 is inserted into the profile 4, a stop face 15 of the connecting plate 8, which plate is integrally formed with the clamping piece 5, abuts against an end surface 14 of the slide channel 1 and thus blocks the clamping piece 5 in its intended position. A surface 16 of the connecting plate 8 oriented towards the sub-construction 3 extends flush with an outside wall 17 of the profile 4 oriented towards the sub-construction 3.

As can be seen particularly in FIG. 5, projections 20 are formed on opposite lateral surfaces 19 of the connecting plate 8, which are overlapped by recesses 21 (see FIGS. 7 and 8) of a cover cap 18, such that the recesses 21 of the cover cap 18 form complementary locking components for the projections 20 of the connecting plate 8.

### LIST OF REFERENCE NUMERALS

1 slide channel
2 attachment device
3 sub-construction
4 profile
5 clamping piece
6 termination on the face side
7 bore
8 connecting plate
9 outside wall
10 inside wall
11 toothing
12 outside wall
13 inside wall
14 end surface
15 stop face
16 surface
17 outside wall
18 cover cap
19 lateral surfaces
20 projections
21 recesses
X detail

1-12. (canceled)

13. An attachment device for a slide channel for a door closer, the attachment device comprising:
a clamping piece insertable into an end of the slide channel, the clamping piece having a first outside surface and a first toothing on the first outside surface; and
a connecting plate integrally formed with the clamping piece and having a bore by which the connecting plate can be connected to a sub-construction,
wherein when the clamping piece is inserted into the end of the slide channel, the connecting plate is disposed outside of the slide channel, and the first toothing abuts against a first inside surface of the end of the slide channel by press fit so that the clamping piece is detachably interlocked with the slide channel.

14. The attachment device of claim 13, wherein the clamping piece has a second outside surface opposite to the first outside surface, and a second toothing on the second outside surface, the end of the slide channel has a second inside surface opposite to the first inside surface, and the second toothing abuts against the second inside surface when the clamping piece is inserted into the end of the slide channel.

15. The attachment device of claim 13, wherein the first toothing is an inclined toothing.

16. The attachment device of claim 14, wherein each of the first and second toothings is an inclined toothing.

17. The attachment device of claim 13, wherein the connecting plate has a stop face which abuts against an end surface of the end of the slide channel when the clamping piece is inserted into the end of the slide channel.

18. The attachment device of claim 13, wherein the slide channel has an outside surface facing the sub-construction, and the connecting plate has a first surface which abuts against the sub-construction and extends flush with the outside surface of the slide channel when the clamping piece is inserted into the end of the slide channel.

19. The attachment device of claim 18, wherein the connecting plate has a locking component for clampingly connecting a cover cap which, when the clamping piece is inserted into the end of the slide channel, covers the connecting plate and the end surface of the slide channel.

20. The attachment device of claim 19, wherein the connecting plate has two opposite lateral surfaces which extend orthogonally to the first surface, at least one of the lateral surfaces has at least one of a projection and a recess.

21. The attachment device of claim 20, wherein the at least one of a projection and a recess of the connecting plate constitutes the locking component for at least one of a recess and a projection of the cover cap.

22. The attachment device of claim 13, wherein the bore has an oblong shaped cross section.

23. The attachment device of claim 13, being comprised of a plastic material.

24. The attachment device of claim 13, being comprised of an aluminium material.

25. The attachment device of claim 13, being comprised of zinc.

26. The attachment device of claim 25, being made by die casting.
